(19) United States
(12) Patent Application Publication
(10) Pub. No.: US 2025/0293743 A1
(43) Pub. Date: Sep. 18, 2025

(54) USER EQUIPMENT FOR REPORTING CHANNEL STATE INFORMATION AND OPERATING METHOD THEREOF

(71) Applicant: Samsung Electronics Co., Ltd., Suwon-si (KR)

(72) Inventors: Jaein Kim, Suwon-si (KR); Jinho Kim, Suwon-si (KR); Kunil Yum, Suwon-si (KR); Yoojin Choi, Suwon-si (KR); Yangsoo Kwon, Suwon-si (KR); Jungmin Park, Suwon-si (KR)

(21) Appl. No.: 19/075,105

(22) Filed: Mar. 10, 2025

(30) Foreign Application Priority Data
Mar. 12, 2024 (KR) 10-2024-0034723
Jun. 25, 2024 (KR) 10-2024-0082873

(51) Int. Cl. H04B 7/06; H04L 5/00; H04L 5/14; H04W 24/10

(52) U.S. Cl. CPC H04B 7/0626; H04L 5/0044; H04L 5/14; H04W 24/10

(57) ABSTRACT

An operating method of a user equipment (UE) in a subband full duplex (SBFD) system, the method including receiving a channel state information-reference signal (CSI-RS) from a base station (BS), generating a plurality of subband groups by grouping, based on interference to downlink channels, a plurality of subbands included in the downlink channels, based on interference to the downlink channels, and generating CSI of the plurality of subband groups, based on the CSI-RS.

### CROSS-REFERENCE TO RELATED APPLICATION

This application is based on and claims priority under 35 U.S.C. § 119 to Korean Patent Application Nos. 10-2024-0034723, filed on Mar. 12, 2024, and 10-2024-0082873, filed on Jun. 25, 2024, in the Korean Intellectual Property Office, the disclosures of which are incorporated by reference herein in their entireties.

### BACKGROUND

Aspects of inventive concept relate to wireless communication, and more particularly, to a user equipment (UE) for reporting channel state information (CSI) in a subband full duplex (SBFD) system and an operating method thereof.

A base station (BS) may transmit reference signals to a UE to obtain channel information between the BS and the UE. For example, the BS may transmit a CSI-reference signal (CSI-RS) to obtain the channel information between the BS and the UE. The UE may identify channels between the BS and the UE through the CSI-RS received from the BS. That is, the UE may estimate the channels between the BS and the UE based on the CSI-RS. The UE may report feedback information on the estimated channels to the BS. The feedback information may include a precoding matrix indicator (PMI), a rank indicator (RI), and a channel quality indicator (CQI). The BS may design a precoder for downlink channels by using the feedback information.

In the SBFD system, in the same time domain, some resources of the downlink channels may be allocated to uplink channels. Accordingly, the coverage of the uplink channels may increase, a latency may decrease, and a capacity may increase, but interference to the downlink channels due to the uplink channels may occur, thereby decreasing the performance of the UE or the BS. Therefore, a channel estimation method considering interference to downlink channels due to uplink channels has been demanded.

### SUMMARY

Aspects of the inventive concept provide a user equipment (UE) for estimating a channel state for each group of a plurality of subbands which have been grouped together and included in downlink channels, based on interference to the downlink channels in a subband full duplex (SBFD) system, and an operating method thereof.

According to an aspect of the inventive concept, there is provided an operating method of a UE in an SBFD system, the method including receiving a channel state information-reference signal (CSI-RS) from a base station (BS), generating a plurality of subband groups by grouping, based on interference to downlink channels, a plurality of subbands included in the downlink channels, and generating, based on the CSI-RS, CSI of the plurality of subband groups.

According to another aspect of the inventive concept, there is provided an operating method of a UE in an SBFD system, the method including receiving a CSI-RS from a BS, measuring, based on CSI-interference measurement (CSI-IM) and a sounding reference signal (SRS), interference to downlink channels in a frequency band of the downlink channels, generating, based on the measured interference, a plurality of subband groups by grouping a plurality of subbands included in the downlink channels, and generating, based on the CSI-RS, CSI of the plurality of subband groups, based on the CSI-RS.

According to another aspect of the inventive concept, there is provided a UE including a plurality of antennas and a processing circuit configured to measure, based on channel state information-interference measurement (CSI-IM) and a sounding reference signal (SRS), interference to downlink channels, generate, based on the measured interference, a plurality of subband groups by grouping a plurality of subbands included in the downlink channels, and generate, based on a CSI-reference signal (RS) received from a base station (BS) through the plurality of antennas, CSI of the plurality of subband groups.

### BRIEF DESCRIPTION OF THE DRAWINGS

Embodiments of the inventive concept will be more clearly understood from the following detailed description taken in conjunction with the accompanying drawings in which:

A simple description is provided for sufficient understanding of the drawings referred to in the detailed description of the embodiments.

FIG. 1 is a block diagram illustrating a wireless communication system according to an embodiment;

FIG. 2 illustrates a subband full duplex (SBFD) system according to an embodiment;

FIG. 3 is a block diagram illustrating a user equipment according to an embodiment;

FIG. 4 is a signaling diagram illustrating a channel state estimation operation according to an embodiment;

FIG. 5 illustrates an operation of grouping a plurality of subbands, according to an embodiment;

FIG. 6 illustrates an operation of grouping a plurality of subbands, according to an embodiment;

FIG. 7 is a flowchart illustrating an operation, performed by a user equipment (UE), of measuring interference to a downlink, according to an embodiment;

FIG. 8 illustrates an operation of measuring interference to the downlink, according to an embodiment;

FIG. 9 illustrates an operation of measuring interference to the downlink, according to an embodiment;

FIG. 10 is a block diagram illustrating a base station in a wireless communication system according to an embodiment;

FIG. 11 is a signaling diagram illustrating a channel state estimation operation according to an embodiment;

FIG. 12 is a block diagram illustrating an electronic device according to an embodiment; and

FIG. 13 is a conceptual diagram illustrating an Internet of Things (IoT) network system to which an embodiment is applied.

### DETAILED DESCRIPTION OF THE EMBODIMENTS

Hereinafter, the embodiments are described based on a new radio (NR) network-based wireless communication system (WCS), for example, 5G NR developed by the third generation partnership project (3GPP), but the technical idea of the inventive concept is not limited to a NR network, and the technical idea of the inventive concept may also be applied to other WCSs (e.g., cellular communication systems, such as long term evolution (LTE), LTE-advanced (LTE-A), wireless broadband (WiBro), and global system for mobile communication (GSM), or short-range communication systems, such as Bluetooth and near field communication (NFC)) having a similar technical background or channel configuration.

In addition, various functions described below may be implemented or supported by artificial intelligence technology or one or more computer programs, and each of the computer programs consists of computer-readable program code and is executed in a computer-readable medium. The terms “application” and “program” indicate one or more computer programs, software components, instruction sets, procedures, functions, objects, classes, instances, relevant data, or some thereof suitable for implementation of appropriate computer-readable program code. The term “computer-readable program code” includes all types of computer code including source code, object code, and execution code. The term “computer-readable medium” includes every type of medium accessible by a computer, such as read only memory (ROM), random access memory (RAM), a hard disk drive, a compact disc (CD), a digital video disc (DVD), or any other type of memory. A “non-transitory” computer-readable medium excludes transitory wired, wireless, optical, or other communication links through which electrical or other signals are transmitted. The non-transitory computer-readable medium includes a medium in which data is permanently stored and a medium in which data is stored and is overwritten by other data later, such as a rewritable optical disc or an erasable memory device.

The embodiments described below employ a hardware-based access method as an example. However, because the embodiments include technology using both hardware and software, the embodiments do not exclude a software-based access method.

Hereinafter, the embodiments are described in detail with reference to the accompanying drawings.

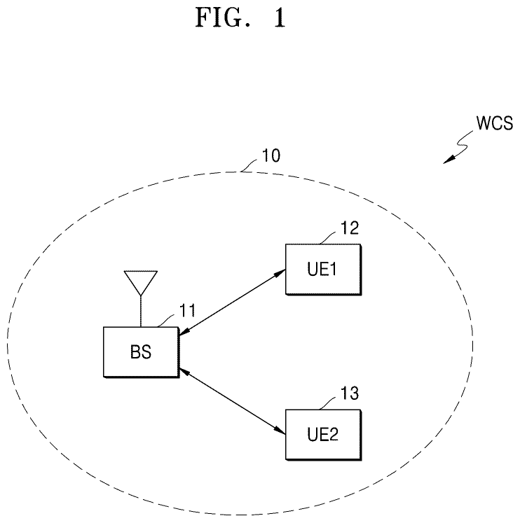

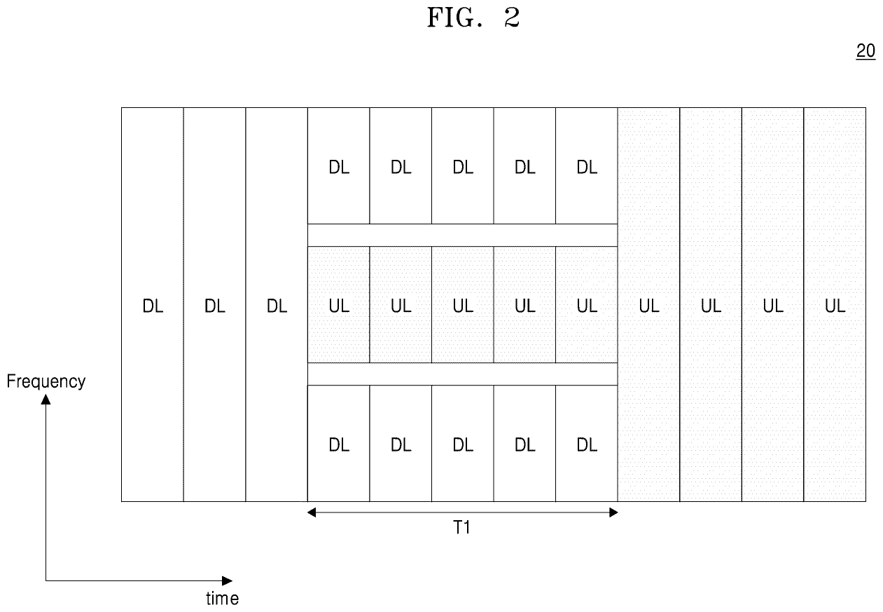

FIG. 1 is a block diagram illustrating a WCS according to an embodiment. FIG. 2 illustrates a subband full duplex (SBFD) system according to an embodiment.

Referring to FIG. 1, the WCS may include a base station (BS) 11, a first user equipment (UE) 12, and a second UE 13. The BS 11 may be generally referred to as a fixed station configured to communicate with the first and second UEs 12 and 13 and/or another BS (not shown) and may exchange data and control information with the first and second UEs 12 and 13 and/or another BS (not shown) by communicating with the same. For example, the BS 11 may be referred to as a cell, a Node B, an evolved-Node B (eNB), a next generation Node B (gNB), a sector, a site, a base transceiver system (BTS), an access point (AP), a relay node, a remote radio head (RRH), a radio unit (RU), a small cell, a device, or the like. The BS 11 may provide WiBro access to the first and second UEs 12 and 13 in a coverage 10 thereof.

The first and second UEs 12 and 13 may be referred to as devices capable of being fixed or having mobility, and transmitting and receiving data and/or control information to and from the BS 11 by communicating with the BS 11. For example, each of the first and second UEs 12 and 13 may be referred to as a terminal, terminal equipment, a mobile station (MS), a mobile terminal (MT), a user terminal (UT), a subscribe station (SS), a wireless communication device, a wireless device, a handheld device, or the like. In the specification, only the first and second UEs 12 and 13 are shown, but aspects of the inventive concept are not limited thereto. For example, only one of the first and second UEs 12 and 13 may be included, or other UEs (not shown) in addition to the first and second UEs 12 and 13 may be further included.

The BS 11 and the first and second UEs 12 and 13 may exchange data and control information by communicating with each other through the SBFD system. The SBFD system may indicate a system for mutual communication in the same time domain by allocating some resources of downlink channels to uplink channels.

In some embodiments, the first and second UEs 12 and 13 of the SBFD system may operate by any one of full-duplex and half-duplex. Full-duplex may indicate an operation in which the first and second UEs 12 and 13 select either uplink channels or downlink channels or use both the uplink channels and the downlink channels, and half-duplex may indicate an operation in which the first and second UEs 12 and 13 select either the uplink channels or the downlink channels.

Further referring to FIG. 2, graph 20 may be a graph for describing the SBFD system. The horizontal axis of the graph 20 may indicate a time domain, and the vertical axis of the graph 20 may indicate a frequency domain. In a period T1, the BS 11 and the first and second UEs 12 and 13 may communicate with each other through the SBFD system, and because resources are allocated to downlink channels DL in the same time domain as that of uplink channels UL in the period T1, interference may occur between the downlink channels DL and the uplink channels UL.

In some embodiments, when the BS 11 communicates with the first UE 12, the first UE 12 may transmit a signal to the BS 11 through uplink channels UL, and the BS 11 may transmit a signal to the first UE 12 through downlink channels DL. In this case, there may occur interference influencing the downlink channels DL by the first UE 12 or the second UE 13.

For example, interference influencing the downlink channels DL may occur by the signal transmitted through the uplink channels UL used by the first UE 12. For example, the second UE 13 may also communicate with the BS 11, and if uplink channels UL used by the second UE 13 are included in the uplink channels UL used by the first UE 12, interference influencing the downlink channels DL may occur by a signal transmitted through the uplink channels UL used by the second UE 13. For example, the second UE 13 may also communicate with the BS 11, and if the uplink channels UL used by the second UE 13 partially or entirely overlap the downlink channels DL used by the first UE 12, interference influencing the downlink channels DL may occur by the signal transmitted through the uplink channels UL used by the second UE 13.

When interference to the downlink channels DL occurs, the performance of the BS 11 or any one of the first and second UEs 12 and 13 may be lowered. To solve this, the WCS according to aspects of the inventive concept may group a plurality of subbands (SBs) included in downlink channels DL based on interference to the downlink channels DL and estimate a channel state for each group.

Accordingly, a different operation for each group (e.g., a different precoder design for each group) may be performed based on the presence/absence of interference by considering interference to downlink channels DL, thereby improving the performance of the BS 11 or any one of the first and second UEs 12 and 13.

In addition, the WCS may estimate a channel state for each group instead of estimating the channel state of each of a plurality of SBs included in downlink channels DL, thereby reducing overhead for uplink channels UL.

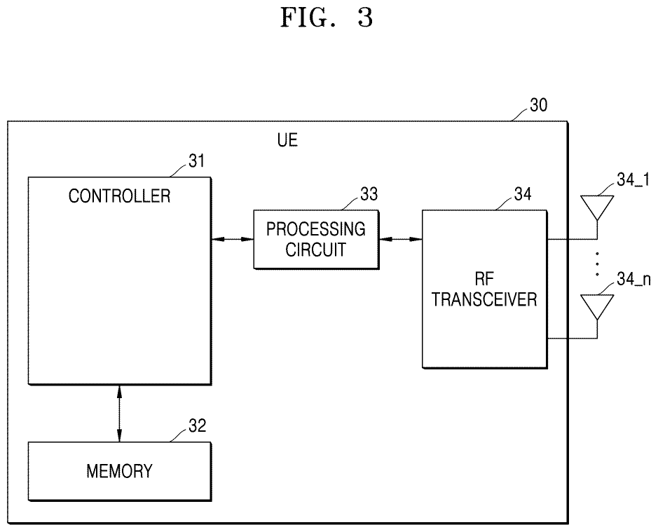

Particular embodiments of an operation of grouping a plurality of SBs in the WCS and estimating a channel state for each group are described below with reference to FIGS. 3 to 13.

FIG. 3 is a block diagram illustrating a UE 30 according to an embodiment. An implementation example of the UE 30 of FIG. 3 may be applied to at least one of the first and second UEs 12 and 13 of FIG. 1.

The UE 30 may include a controller 31, a memory 32, a processing circuit 33, a radio frequency (RF) transceiver 34, and a plurality of antennas 34_1 to 34_n. The RF transceiver 34 may receive RF signals transmitted by the BS 11 of FIG. 1, through the plurality of antennas 34_1 to 34_n. The RF transceiver 34 may generate intermediate frequency (IF) or baseband signals by down-converting the received RF signals. The RF transceiver 34 may perform frequency up-conversion of IF or baseband signals output from the processing circuit 33 into RF signals and transmit the RF signals through the plurality of antennas 34_1 to 34_n.

The processing circuit 33 may generate data signals by filtering, decoding, and/or digitizing IF or baseband signals and receive data signals from the controller 31. The processing circuit 33 may encode, multiplex, and/or analog-convert the received data signals.

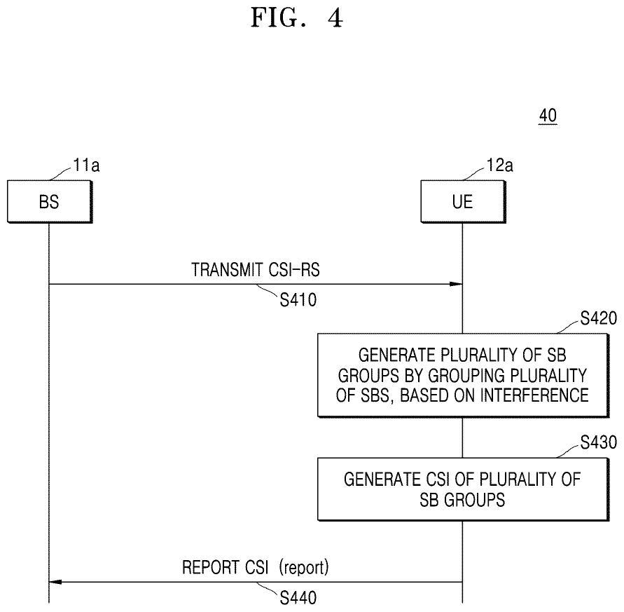

In some embodiments, the controller 31 may control an operation of the processing circuit 33, and the processing circuit 33 may generate a plurality of SB groups by grouping a plurality of SBs included in downlink channels, based on interference to the downlink channels. The processing circuit 33 may generate channel state information (CSI) of the plurality of SB groups based on a CSI-reference signal (RS) received from the BS 11. A particular embodiment of the processing circuit 33 is described below with reference to FIGS. 4 to 9.

The controller 31 may additionally process data signals and, to perform a general control operation on the UE 30, execute a program and/or a process stored in the memory 32.

The memory 32 may have an arbitrary structure storing data. For example, the memory 32 may include a volatile memory device, such as dynamic random access memory (DRAM) or static random access memory (SRAM), or a non-volatile memory device, such as flash memory or resistive random access memory (RRAM).

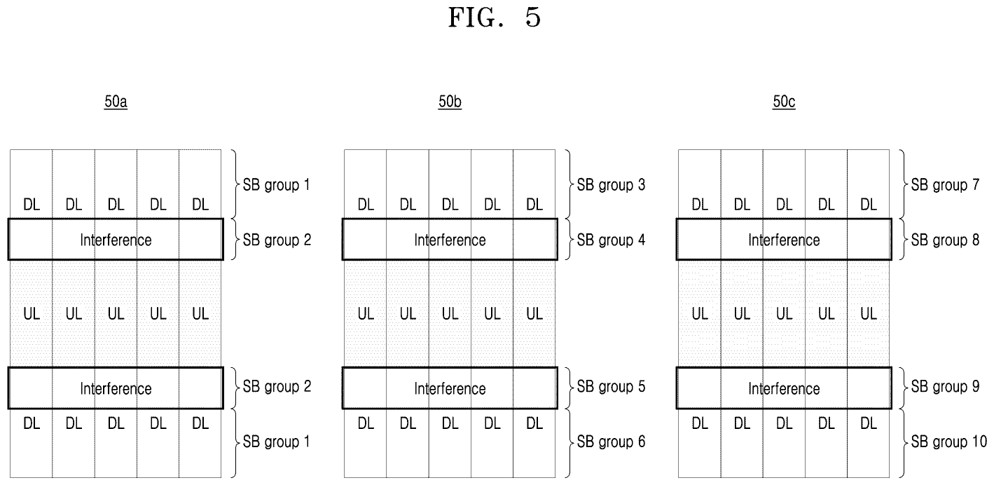

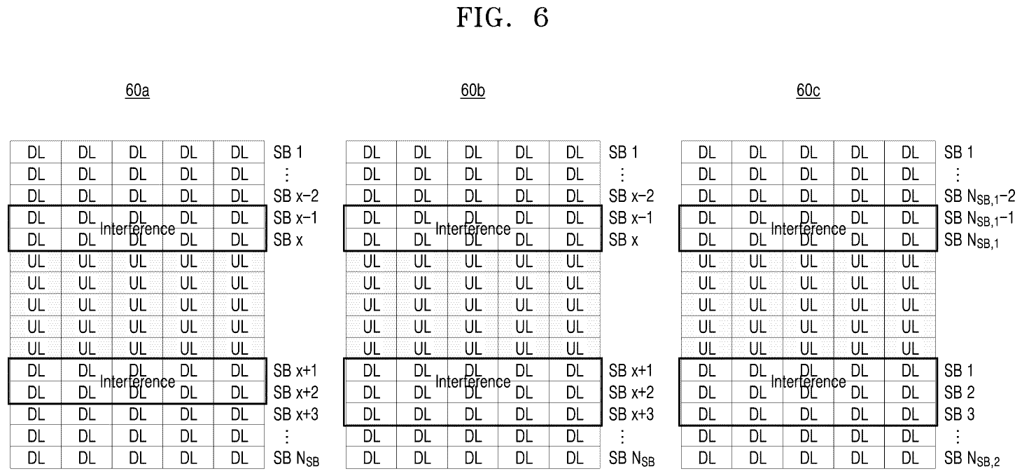

FIG. 4 is a signaling diagram illustrating a channel state estimation operation according to an embodiment. FIG. 5 illustrates an operation of grouping a plurality of SBs, according to an embodiment. FIG. 6 illustrates an operation of grouping a plurality of SBs, according to an embodiment.

Referring to FIG. 4, an operating method 40 of a WCS for performing a channel state estimation operation may include a plurality of operations S410 to S440, and a BS 11a and a UE 12a may be examples of the BS 11 and the first UE 12 (or the UE 30 of FIG. 3) of FIG. 1, respectively. The description made above with reference to FIGS. 1 and 3 is omitted below for brevity.

In operation S410, the UE 12a may receive a CSI-RS from the BS 11a. The CSI-RS may indicate an RS used to estimate the channel state of downlink channels. In some embodiments, the processing circuit 33 of FIG. 3 may receive the CSI-RS from the BS 11a through the plurality of antennas 34_1 to 34_n.

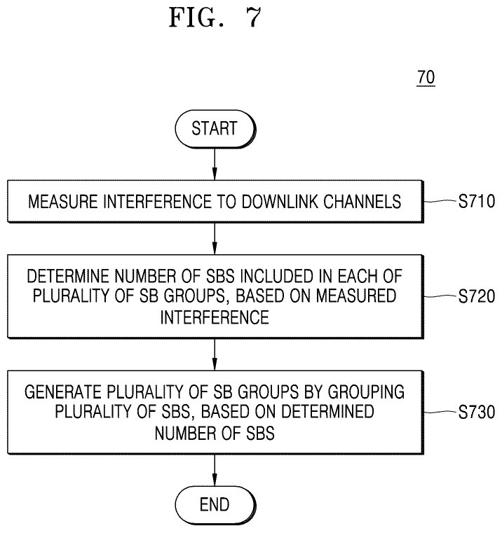

In operation S420, the UE 12a may generate a plurality of SB groups by grouping a plurality of SBs included in downlink channels, based on interference. In some embodiments, the UE 12a may measure interference to the downlink channels. A particular embodiment, in which the UE 12a measures interference to downlink channels, is described below with reference to FIGS. 7 to 9.

In some embodiments, the UE 12a may generate a plurality of SB groups by differently grouping a plurality of SBs included in downlink channels, according to the number of times of reporting CSI based on interference to the downlink channels. Interference due to uplink channels may occur in a partial area of downlink channels adjacent to the uplink channels, and the interference due to the uplink channels may not occur in the other area of the downlink channels separated from the uplink channels.

Further referring to FIG. 5, a first grouping example 50a may indicate that a plurality of SBs included in downlink channels are grouped into two groups when the UE 12a reports, to the BS 11a at one time, downlink channels on uplink channels and downlink channels beneath the uplink channels based on a frequency domain. It may be assumed that interference to the downlink channels on the uplink channels based on the frequency domain is the same as interference to the downlink channels beneath the uplink channels based on the frequency domain. In some embodiments, the UE 12a may generate a first SB group by grouping SBs included in an area of downlink channels, in which no interference has occurred, and generate a second SB group by grouping SBs included in an area of the downlink channels, in which interference has occurred.

A second grouping example 50b may indicate that a plurality of SBs included in downlink channels are grouped into four groups when the UE 12a reports, to the BS 11a at one time, downlink channels on uplink channels and downlink channels beneath the uplink channels based on the frequency domain. It may be assumed that interference to the downlink channels on the uplink channels based on the frequency domain is different from interference to the downlink channels beneath the uplink channels based on the frequency domain. In some embodiments, the UE 12a may generate a third SB group by grouping SBs included in an area of the downlink channels on the uplink channels, in which no interference has occurred, and generate a fourth SB group by grouping SBs included in an area of the downlink channels on the uplink channels, in which interference has occurred. The UE 12a may generate a fifth SB group by grouping SBs included in an area of the downlink channels beneath the uplink channels, in which interference has occurred, and generate a sixth SB group by grouping SBs included in an area of the downlink channels beneath the uplink channels, in which no interference has occurred. The sixth SB group and the third SB group may be included in the same group. For example, the third SB group and the sixth SB group may be referred to as the same SB group.

A third grouping example 50c may indicate that a plurality of SBs included in downlink channels are grouped into four groups when the UE 12a separately reports, to the BS 11a, downlink channels on uplink channels and downlink channels beneath the uplink channels based on the frequency domain. It may be assumed that interference to the downlink channels on the uplink channels based on the frequency domain is different from interference to the downlink channels beneath the uplink channels based on the frequency domain. In some embodiments, the UE 12a may generate a seventh SB group by grouping SBs included in an area of the downlink channels on the uplink channels, in which no interference has occurred, and generate an eighth SB group by grouping SBs included in an area of the downlink channels on the uplink channels, in which interference has occurred. The UE 12a may generate a ninth SB group by grouping SBs included in an area of the downlink channels beneath the uplink channels, in which interference has occurred, and generate a tenth SB group by grouping SBs included in an area of the downlink channels beneath the uplink channels, in which no interference has occurred.

Further referring to FIG. 6, a fourth grouping example 60a, a fifth grouping example 60b, and a sixth grouping example 60c are illustrated and described in further detail below. The description made above with reference to FIG. 5 is omitted below for brevity.

In some embodiments, the UE 12a may determine the number of SBs, in which interference has occurred, among SBs included in downlink channels, based on measured interference, and generate a plurality of SB groups by grouping a plurality of SBs based on the determined number. For example, the UE 12a may determine, as SBs in which interference has occurred, SBs having measured interference that is greater than reference interference (e.g., a preset threshold), and determine the number of SBs, in which interference has occurred, based on the determination.

For example, in the fourth grouping example 60a, the number of SBs included in downlink channels is N_{SB}, and the indices of the SBs may be represented by SB 1 to SB N_{SB}. In the fourth grouping example 60a, the UE 12a may determine the number of SBs, in which interference has occurred, as 4 among the SBs included in the downlink channels, based on measured interference. For example, based on measured interference, it may be determined that interference has occurred in SBs SB x−1, SB x, SB x+1, and SB x+2. With respect to fourth grouping example 60a, it is assumed that interference to downlink channels on uplink channels based on the frequency domain is the same as interference to downlink channels beneath the uplink channels based on the frequency domain. Accordingly, the UE 12a may generate the second SB group by grouping SBs SB x−1, SB x, SB x+1, and SB x+2. The first SB group may be generated by grouping the remaining SBs (e.g., SB 1 to SB x−2 and SB x+3 to SB N_{SB}. In the fourth grouping example 60a, the size of information which the UE 12a has to report to the BS 11a may be relatively small, and the UE 12a may relatively quickly perform a reporting operation.

For example, in the fifth grouping example 60b, the number of SBs included in downlink channels is N_{SB}, and the indices of the SBs may be represented by SB 1 to SB N_{SB}. In the fifth grouping example 60b, the UE 12a may determine the number of SBs, in which interference has occurred, as 5 among the SBs included in the downlink channels, based on measured interference. For example, based on measured interference, it may be determined that interference has occurred in SBs SB x−1, SB x, SB x+1, SB x+2, and SB x+3. With respect to the fifth grouping example 60b, it is assumed that interference to downlink channels on uplink channels based on the frequency domain is different from interference to downlink channels beneath the uplink channels based on the frequency domain. Accordingly, the UE 12a may generate the fourth SB group by grouping SBs corresponding to SB x−1 and SB x. The UE 12a may generate the fifth SB group by grouping SBs corresponding to SB x+1, SB x+2, and SB x+3. The UE 12a may generate the third SB group by grouping SBs corresponding to SB 1 to SB x−2 and generate the sixth SB group by grouping SBs corresponding to SB x+4 to SB N_{SB}. In the fifth grouping example 60b, because the numbers of SBs, in which interference has occurred, are differently determined based on uplink channels, interference to downlink channels may be elaboratively considered.

For example, in the sixth grouping example 60c, the number of SBs included in downlink channels on uplink channels is N_{SB,1}, and the indices of the SBs may be represented by SB 1 to SB N_{SB,1}. The number of SBs included in downlink channels beneath the uplink channels is N_{SB,2}, and the indices of the SBs may be represented by SB 1 to SB N_{SB,2}. In the sixth grouping example 60c, the UE 12a may determine the number of SBs, in which interference has occurred, as 5 among the SBs included in the downlink channels, based on measured interference. For example, based on measured interference, it may be determined that interference has occurred in SBs SB N_{SB,1}−1 and SB N_{SB,1}, SB 1, SB 2, and SB 3. With respect to the sixth grouping example 60c, it is assumed that interference to downlink channels on uplink channels based on the frequency domain is different from interference to downlink channels beneath the uplink channels based on the frequency domain. Accordingly, the UE 12a may generate the eighth SB group by grouping SBs corresponding to SB N_{SB,1}−1 and SB N_{SB,1}. The UE 12a may generate the ninth SB group by grouping SBs corresponding to SB 1 to SB 3. The UE 12a may generate the seventh SB group by grouping SBs corresponding to SB 1 to SB N_{SB,1}−2 and generate the tenth SB group by grouping SBs corresponding to SB 4 to SB N_{SB,2}.

In some embodiments, the size of SBs included in downlink channels may be set based on the number of resource blocks (RBs) of a CSI-RS. For example, the UE 12a may set the size of an SB based on the total number of RBs of a CSI-RS corresponding to the SBs included in the downlink channels in the fourth grouping example 60a and the fifth grouping example 60b.

For example, in the sixth grouping example 60c, the UE 12a may set the size of an SB based on the number of RBs of a CSI-RS corresponding to the SBs included in the downlink channels on the uplink channels and set the size of an SB based on the number of RBs of a CSI-RS corresponding to the SBs included in the downlink channels beneath the uplink channels. The size of an SB according to the number of RBs of a CSI-RS may be illustrated in Table 1 below, and the BS 11a may set the size of an SB through radio resource control (RRC) signaling.

TABLE 1

| CSI-RS | Subband |
|---|---|
| (PRBs) | size (PRBs) |
| 24-72 | 4, 8 |
| 73-144 | 8, 16 |
| 145-275 | 16, 32 |

In the SBFD system, resources are allocated to downlink channels in the same time domain as that of uplink channels, and thus, a bandwidth allocated to the downlink channels may be less than a bandwidth allocated to downlink channels of a time division duplex (TDD) system. Accordingly, the UE 12a according to aspects of the inventive concept may more elaboratively set an SB size and more accurately divide an area to which interference is influenced than a case of setting an SB size in correspondence to downlink channels of the TDD system.

Referring back to FIG. 4, in operation S430, the UE 12a may generate CSI of the plurality of SB groups. In some embodiments, the CSI may include any one of a channel quality indicator (CQI) and a precoding matrix indicator (PMI) of each of the plurality of SB groups.

For example, the UE 12a may generate CSI by estimating information on a CQI or a PMI based on the plurality of SB groups as well as generating CSI by estimating information on a CQI or a PMI based on an SB. Table 2 may illustrate a CQI index set based on the plurality of SB groups.

TABLE 2

| Sub-band group | |
|---|---|
| differential | Offset |
| CQI value [symbol] | level [symbol] |
| 0 [symbol] | 0 [symbol] |
| 1 [symbol] | 1 [symbol] |
| 2 [symbol] | ≥2 [symbol] |
| 3 [symbol] | ≤−1 [symbol] |

Herein, an offset level may indicate the difference between an SB group and a wideband (WB) CQI.

In operation S440, the UE 12a may report the generated CSI to the BS 11a. In some embodiments, the BS 11a may perform a different operation for each group (e.g., a different precoder design for each group) according to the presence/absence of interference based on the received CSI.

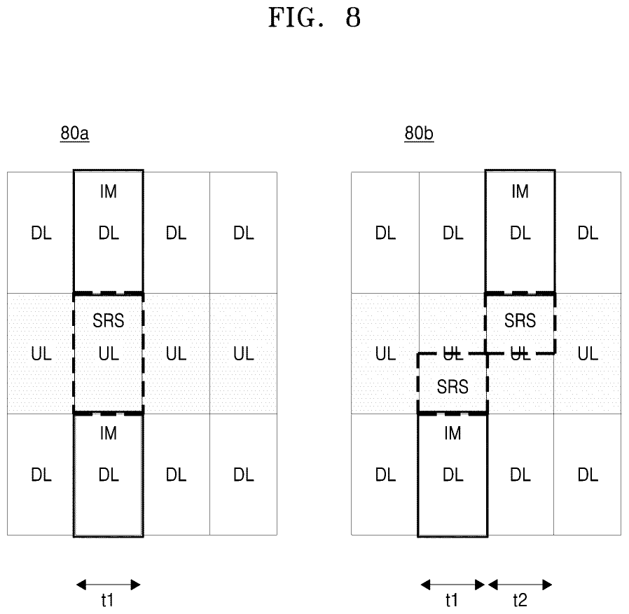

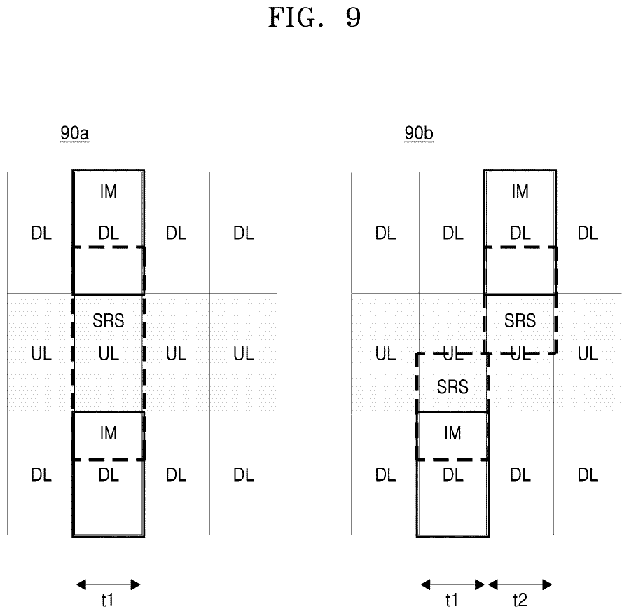

FIG. 7 is a flowchart illustrating an operation, performed by a UE, of measuring interference to a downlink, according to an embodiment. FIG. 8 illustrates an operation of measuring interference to the downlink, according to an embodiment. FIG. 9 illustrates an operation of measuring interference to the downlink, according to an embodiment.

Referring to FIG. 7, an operating method 70, performed by a UE, of measuring interference to the downlink may include a plurality of operations S710 to S730. Further referring to FIG. 1, in operation S710, the first UE 12 may measure interference to downlink channels. In some embodiments, the first UE 12 may receive CSI-interference measurement (IM) from the BS 11 and measure the interference to the downlink channels in the frequency band of the downlink channels, based on the CSI-IM. For example, the CSI-IM may correspond to the bandwidth of downlink channels in the TDD system, and because resources are allocated to downlink channels in the same time domain as that of uplink channels in the SBFD system, the downlink channels in the SBFD system may have less bandwidth than the downlink channels in the TDD system. Even when the CSI-IM corresponds to the bandwidth of the downlink channels in the TDD system, the first UE 12 may measure interference by setting, through RRC signaling from the BS 11, the CSI-IM so as to correspond to the bandwidth of the downlink channels in the SBFD system. Alternatively, the first UE 12 may measure interference by setting, through a processor (e.g., the processing circuit 33 of FIG. 3), the CSI-IM so as to correspond to the bandwidth of the downlink channels in the SBFD system.

In some embodiments, the first UE 12 may transmit a sounding reference signal (SRS) to the BS 11 by using the same precoding as that for a physical uplink shared channel (PUSCH). The CSI-IM may be set to be located in the same symbol as the SRS.

For example, further referring to FIG. 8, it may be assumed that interference influencing downlink channels DL occurs by a signal transmitted through uplink channels UL used by the first UE 12 or that interference influencing downlink channels DL occurs by a signal transmitted through uplink channels UL used by the second UE 13 because the uplink channels UL used by the second UE 13 are included in the uplink channels UL used by the first UE 12. A first interference example 80a may indicate a case where there is no SRS hopping and CSI-IM is located in the same symbol t1 as an SRS. A second interference example 80b may indicate a case where there is SRS hopping and CSI-IM is located in the same symbols t1 and t2 as adjacent SRSs, respectively. SRS hopping may indicate that an SRS signal is divided based on a frequency band.

For example, further referring to FIG. 9, it may be assumed that there occurs interference influencing downlink channels DL by a signal transmitted through uplink channels UL used by the second UE 13 when the uplink channels UL used by the second UE 13 partially or entirely overlap the downlink channels DL used by the first UE 12. A third interference example 90a may indicate a case where there is no SRS hopping and CSI-IM is located in the same symbol t1 as an SRS. A fourth interference example 90b may indicate a case where there is SRS hopping and CSI-IM is located in the same symbols t1 and t2 as adjacent SRSs, respectively.

When the same precoding as that for a PUSCH is used for an SRS, the SRS may be transmitted through the same channel as that through which the PUSCH is transmitted, and like the PUSCH, interference to downlink channels due to uplink channels may be identified through the SRS. Accordingly, when it is set that CSI-IM is located in the same symbol as an SRS, the first UE 12 may measure interference to downlink channels due to uplink channels, based on the CSI-IM and the SRS.

Referring back to FIG. 7, in operation S720, the first UE 12 may determine the number of SBs included in each of a plurality of SB groups, based on the measured interference. In some embodiments, the first UE 12 may determine, as SBs in which interference has occurred, SBs having measured interference that is greater than reference interference (e.g., a preset threshold), and determine the number of SBs, in which interference has occurred, based on the determination.

In operation S730, the first UE 12 may generate the plurality of SB groups by grouping a plurality of SBs based on the determined number of SBs. In some embodiments, the first UE 12 may generate the plurality of SB groups in the same manner as the fourth to sixth grouping examples 60a to 60c as described above with reference to FIG. 6.

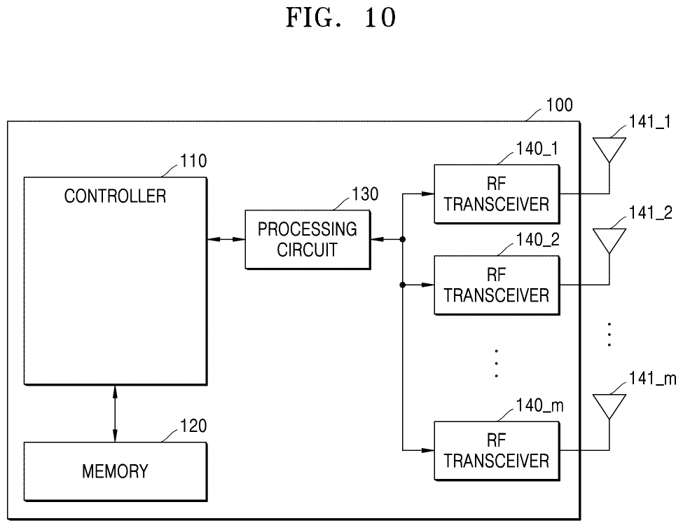

FIG. 10 is a block diagram illustrating a BS 100 in a WCS according to an embodiment. An implementation example of the BS 100 of FIG. 10 may be applied to the BS 11 of FIG. 1.

The BS 100 may include a controller 110, a memory 120, a processing circuit 130, a plurality of RF transceivers 140_1 to 140_m, and a plurality of antennas 141_1 to 141_m. The plurality of RF transceivers 140_1 to 140_m may receive, via the plurality of antennas 141_1 to 141_m, RF signals transmitted from a UE (e.g., at least one of the first and second UEs 12 and 13 of FIG. 1) within a coverage. The plurality of RF transceivers 140_1 to 140_m may generate IF or baseband signals by down-converting the received RF signals.

The controller 110 may additionally process data signals. In some embodiments, a program and/or a process stored in the memory 120 may be executed to perform a general control operation on the BS 100.

The processing circuit 130 may generate data signals by filtering, decoding, and/or digitizing IF or baseband signals and receive data signals from the controller 110. The processing circuit 130 may encode, multiplex, and/or analog-convert the received data signals. The plurality of RF transceivers 140_1 to 140_m may perform frequency up-conversion of the IF or baseband signals output from the processing circuit 130 into RF signals and transmit the RF signals to the UE (e.g., at least one of the first and second UEs 12 and 13 of FIG. 1) via the plurality of antennas 141_1 to 141_m.

In some embodiments, the controller 110 may control an operation of the processing circuit 130, and the processing circuit 130 may determine the number of SBs included in downlink channels included in each of a plurality of SB groups, based on interference to the downlink channels, and transmit the determined number to the UE (e.g., at least one of the first and second UEs 12 and 13 of FIG. 1) through RRC signaling.

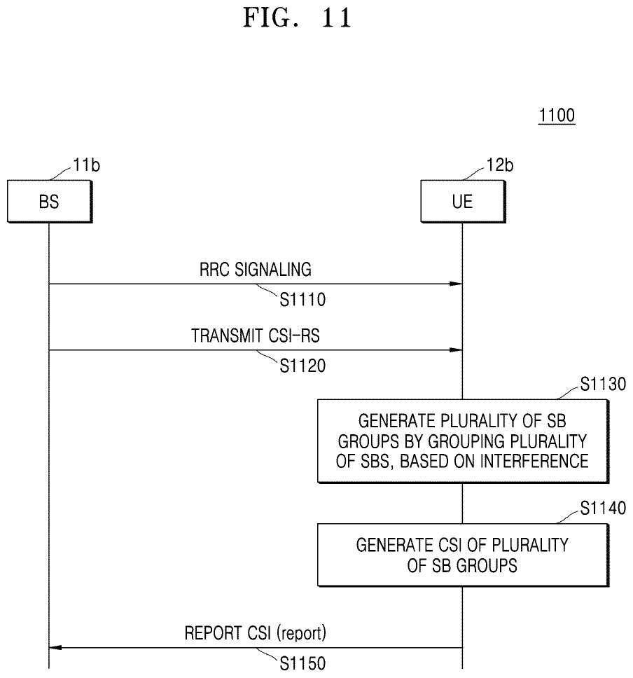

FIG. 11 is a signaling diagram illustrating a channel state estimation operation according to an embodiment.

Referring to FIG. 11, an operating method 1100 of performing a channel state estimation operation in a WCS may include a plurality of operations S1110 to S1150, and a BS 11b and a UE 12b may be examples of the BS 11 (or the BS 100 of FIG. 10) and the first UE 12 of FIG. 1, respectively. The description made above with reference to FIGS. 1 and 10 is omitted below for brevity.

In operation S1110, the BS 11b may transmit CSI-RS related information to the UE 12b through RRC signaling. In some embodiments, the CSI-RS related information may include a CSI-RS reporting unit (e.g., any one of a WB, an SB, and an SB group), a reporting period, CSI related information to be reported (e.g., any one of a PMI and a CQI), the number of SBs included in downlink channels included in each of a plurality of SB groups, the size of the SBs, and the like. In some embodiments, the BS 11b may transmit the number of SBs included in the downlink channels included in each of the plurality of SB groups to the UE 12b in a bitmap format.

In operation S1120, the BS 11b may transmit a CSI-RS to the UE 12b. The CSI-RS may indicate a reference signal used to estimate the channel state of the downlink channels. In some embodiments, the processing circuit 130 of FIG. 9 may transmit the CSI-RS to the UE 12b via the plurality of antennas 141_1 to 141_m.

In operation S1130, the UE 12b may generate the plurality of SB groups by grouping a plurality of SBs based on interference. In some embodiments, the BS 11b may determine the number of SBs included in the downlink channels included in each of the plurality of SBs, based on pre-measured interference, or adaptively determine the number of SBs included in the downlink channels included in each of the plurality of SBs. The UE 12b may receive, through RRC signaling, the number of SBs included in the downlink channels included in each of the plurality of SBs, which is determined by the BS 11b, and generate the plurality of SB groups by grouping the plurality of SBs based on the received number.

In operation S1140, the UE 12b may generate CSI of the plurality of SB groups. In some embodiments, the CSI may include any one of a CQI and a PMI of each of the plurality of SB groups. For example, the UE 12b may generate CSI by estimating information on a CQI or a PMI based on the plurality of SB groups as well as generating CSI by estimating information on a CQI or a PMI based on an SB, based on the CSI-RS related information received from the BS 11b.

In operation S1150, the UE 12b may report the generated CSI to the BS 11b. In some embodiments, the BS 11b may perform a different operation for each group (e.g., a different precoder design for each group) according to the presence/absence of interference based on the received CSI.

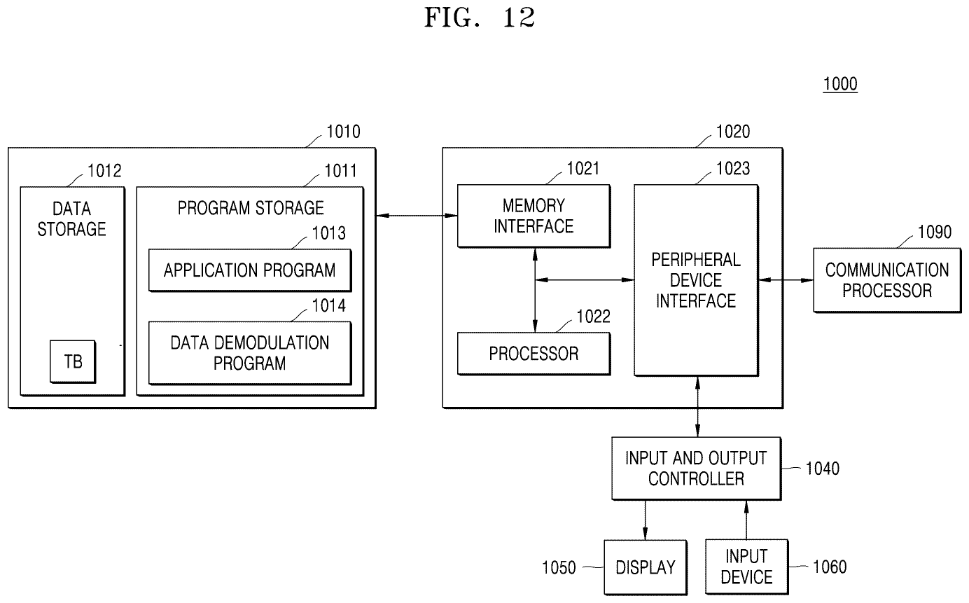

FIG. 12 is a block diagram illustrating an electronic device 1000 according to an embodiment. The electronic device 1000 may be a UE according to an embodiment.

Referring to FIG. 12, the electronic device 1000 may include a memory 1010, a processor unit 1020, an input and output controller 1040, a display 1050, an input device 1060, and a communication processor 1090. Herein, a plurality of memories 1010 may be included. Each component is described below.

The memory 1010 may include a program storage 1011 storing a program for controlling an operation of the electronic device 1000 and a data storage 1012 storing data generated while executing the program. The data storage 1012 may store data necessary for operations of an application program 1013 and a data demodulation program 1014 or store data generated by the operations of the application program 1013 and the data demodulation program 1014.

The program storage 1011 may include the application program 1013 and the data demodulation program 1014. Herein, a program stored in the program storage 1011 may be represented as an instruction set that is a set of instructions. The application program 1013 may include program code for executing various applications operating in the electronic device 1000. That is, the application program 1013 may include code (or commands) related to various applications driven by a processor 1022.

The electronic device 1000 may include the communication processor 1090 configured to perform a communication function for voice communication and data communication. A peripheral device interface 1023 may control connections among the input and output controller 1040, the communication processor 1090, the processor 1022, and a memory interface 1021. The processor 1022 may control a plurality of BSs to provide a corresponding service by using at least one software program. In this case, the processor 1022 may provide a service corresponding to a corresponding program by executing at least one program stored in the memory 1010.

The processor 1022 may estimate a channel state for each group by grouping a plurality of SBs included in downlink channels based on interference to the downlink channels, as described with reference to FIGS. 1 to 11. Accordingly, a different operation for each group (e.g., a different precoder design for each group) may be performed according to the presence/absence of interference by considering interference to downlink channels DL, thereby improving the performance of the electronic device 1000.

The input and output controller 1040 may provide interfaces between input and output devices, such as the display 1050 and the input device 1060, and the peripheral device interface 1023. The display 1050 may display state information, input characters, a moving picture, a still picture, and the like. For example, the display 1050 may display information on an application program driven by the processor 1022.

The input device 1060 may provide input data generated by selection of the electronic device 1000 to the processor unit 1020 via the input and output controller 1040. In this case, the input device 1060 may include a keypad including at least one hardware button, a touch pad configured to sense touch information, and the like. For example, the input device 1060 may provide touch information, such as a touch, touch movement, or touch release, sensed through the touch pad to the processor 1022 via the input and output controller 1040.

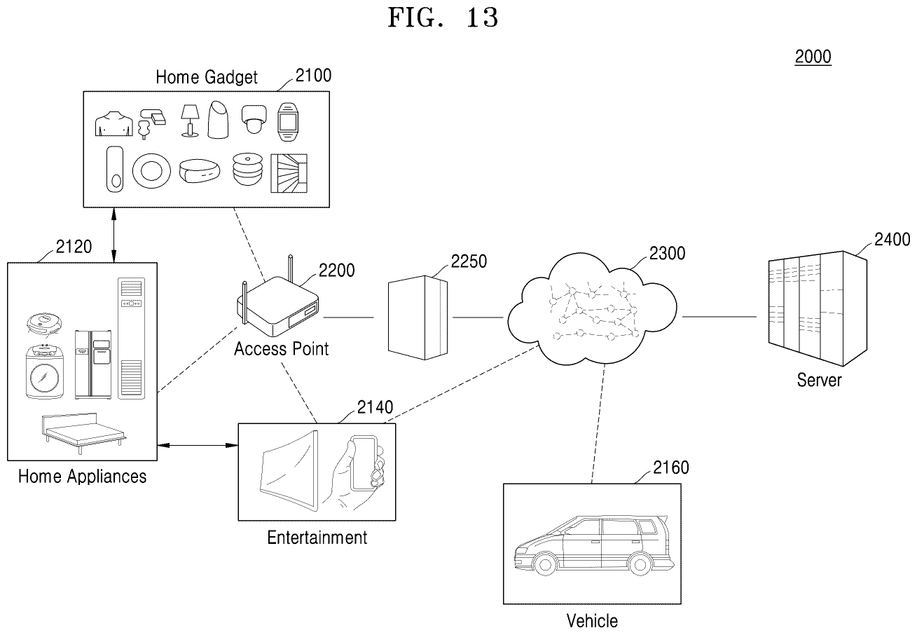

FIG. 13 is a conceptual diagram illustrating an Internet of Things (IoT) network system 2000 to which an embodiment is applied.

Referring to FIG. 13, the IoT network system 2000 may include a plurality of IoT devices 2100, 2120, 2140, and 2160, an AP 2200, a gateway 2250, a radio network 2300, and a server 2400. IoT may indicate a network between things using wired/wireless communication.

Each of the plurality of IoT devices 2100, 2120, 2140, and 2160 may form groups according to the characteristics thereof. For example, each of the plurality of IoT devices may be grouped into a home gadget group 2100, a home appliance/furniture group 2120, an entertainment group 2140, a vehicle group 2160, and the like. The IoT devices 2100, 2120, and 2140 may be connected to a communication network or other IoT devices via the AP 2200. The AP 2200 may be embedded in one IoT device. The gateway 2250 may change a protocol such that the AP 2200 is connected to an external radio network. The IoT devices 2100, 2120, and 2140 may be connected to an external communication network via the gateway 2250. The radio network 2300 may include the Internet and/or a public network. The plurality of IoT devices 2100, 2120, 2140, and 2160 may be connected, via the radio network 2300, to the server 2400 configured to provide a certain service, and a user may use the service through at least one of the plurality of IoT devices 2100, 2120, 2140, and 2160.

Each of the plurality of IoT devices 2100, 2120, 2140, and 2160 may estimate a channel state for each group by grouping a plurality of SBs included in downlink channels, based on interference to the downlink channels, as described with reference to FIGS. 1 to 11. Accordingly, a different operation for each group (e.g., a different precoder design for each group) may be performed according to the presence/absence of interference by considering interference to downlink channels DL, thereby improving the performance of the electronic device 1000.

While aspects of the inventive concept have been particularly shown and described with reference to embodiments thereof, it will be understood that various changes in form and details may be made therein without departing from the spirit and scope of the following claims.

What is claimed is:

1. An operating method of a user equipment (UE) in a subband full duplex (SBFD) system, the method comprising:
receiving a channel state information-reference signal (CSI-RS) from a base station (BS);
generating a plurality of subband groups by grouping, based on interference to downlink channels, a plurality of subbands included in the downlink channels; and
generating, based on the CSI-RS, CSI of the plurality of subband groups.

2. The method of claim 1, wherein
the generating of the plurality of subband groups comprises:
measuring interference to the downlink channels;
determining, based on the measured interference, a number of subbands included in each of the plurality of subband groups; and
generating the plurality of subband groups by grouping the plurality of subbands based on the determined number of subbands.

3. The method of claim 2, wherein
the measuring of the interference to the downlink channels comprises:
receiving CSI-interference measurement (CSI-IM) from the BS; and
measuring, based on the CSI-IM, the interference to the downlink channels in a frequency band of the downlink channels.

4. The method of claim 3, wherein
the measuring of the interference to the downlink channels further comprises
transmitting a sounding reference signal (SRS) to the BS by using the same precoding as that for a physical uplink shared channel (PUSCH), and
the CSI-IM is set to be located in the same symbol as the SRS.

5. The method of claim 1, wherein
the generating of the plurality of subband groups comprises:
determining, by the BS, a number of subbands included in each of the plurality of subband groups based on the interference to the downlink channels;
receiving the determined number of subbands from the BS through radio resource control (RRC) signaling; and
generating the plurality of subband groups by grouping the plurality of subbands based on the determined number of subbands.

6. The method of claim 1, wherein a size of the plurality of subbands is set based on a number of resource blocks (RBs) of the CSI-RS.

7. The method of claim 6, wherein
the size of the plurality of subbands is set based on:
a total number of RBs of the CSI-RS when a number of times of reporting the CSI to the BS is 1; and
a number of RBs of a CSI-RS corresponding to each report when the number of times of reporting the CSI to the BS is 2.

8. The method of claim 1, wherein
the generating of the plurality of subband groups comprises generating a first subband group and a second subband group by grouping the plurality of subbands when a number of times of reporting the CSI to the BS is 1,
the second subband group has relatively greater influence of the interference than the first subband group, and
the plurality of subband groups comprise the first subband group and the second subband group.

9. The method of claim 1, wherein
the generating of the plurality of subband groups comprises generating a third subband group, a fourth subband group, a fifth subband group, and a sixth subband group by grouping the plurality of subbands when a number of times of reporting the CSI to the BS is 1,
the fourth subband group has relatively greater influence of the interference than the third subband group,
the fifth subband group has relatively greater influence of the interference than the sixth subband group,
a number of subbands included in the fourth subband group is different from a number of subbands included in the fifth subband group, and
the plurality of subband groups comprise the third to sixth subband groups.

10. The method of claim 1, wherein
the generating of the plurality of subband groups comprises generating a seventh subband group, an eighth subband group, a ninth subband group, and a tenth subband group by grouping the plurality of subbands when a number of times of reporting the CSI to the BS is 2,
the eighth subband group has relatively greater influence of the interference than the seventh subband group,
the ninth subband group has relatively greater influence of the interference than the tenth subband group, and
the plurality of subband groups comprise the seventh to tenth subband groups.

11. The method of claim 1, wherein
the CSI comprises any one of a channel quality indicator (CQI) and a precoding matrix indicator (PMI) of each of the plurality of subband groups.

12. The method of claim 1, wherein the UE operates in any one of full-duplex and half-duplex.

13. An operating method of a user equipment (UE) in a subband full duplex (SBFD) system, the method comprising:
receiving a channel state information-reference signal (CSI-RS) from a base station (BS);
measuring, based on CSI-interference measurement (CSI-IM) and a sounding reference signal (SRS), interference to downlink channels in a frequency band of the downlink channels;
generating, based on the measured interference, a plurality of subband groups by grouping a plurality of subbands included in the downlink channels; and
generating, based on the CSI-RS, CSI of the plurality of subband groups.

14. The method of claim 13, wherein
the SRS uses the same precoding as that for a physical uplink shared channel (PUSCH), and
the CSI-IM is set to be located in the same symbol as the SRS.

15. The method of claim 13, wherein a size of the plurality of subbands is set based on a number of resource blocks (RBs) of the CSI-RS.

16. The method of claim 13, wherein
the CSI comprises any one of a channel quality indicator (CQI) and a precoding matrix indicator (PMI) of each of the plurality of subband groups.

17. The method of claim 13, wherein
the generating of the plurality of subband groups comprises determining a number of subband groups, based on a number of times of reporting the CSI to the BS.

18. The method of claim 13, wherein
the generating of the plurality of subband groups comprises:
determining a number of subbands included in each of the plurality of subband groups, based on presence/absence of influence of the measured interference to the plurality of subbands; and
generating the plurality of subband groups by grouping the plurality of subbands based on the determined number of subbands.

19. A user equipment (UE) comprising:
a plurality of antennas; and
a processing circuit configured to
measure, based on channel state information-interference measurement (CSI-IM) and a sounding reference signal (SRS), interference to downlink channels,
generate, based on the measured interference, a plurality of subband groups by grouping a plurality of subbands included in the downlink channels, and
generate, based on a CSI-reference signal (RS) received from a base station (BS) through the plurality of antennas, CSI of the plurality of subband groups.

20. The UE of claim 19, wherein
the SRS uses the same precoding as that for a physical uplink shared channel (PUSCH),
the CSI-IM is set to be located in the same symbol as the SRS, and
the processing circuit is further configured to determine a number of subband groups, based on a number of times of reporting the CSI to the BS and generate the plurality of subband groups by grouping the plurality of subbands based on the determined number.
